(19) United States
(12) Patent Application Publication
(10) Pub. No.: US 2021/0086365 A1
(43) Pub. Date: Mar. 25, 2021

(54) MULTI-JOINT ROBOT TEACHING DATA GENERATION METHOD AND TEACHING DATA CALIBRATION COORDINATE SYSTEM DETECTOR

(71) Applicant: KEYLEX CORPORATION, Hiroshima (JP)

(72) Inventors: Narumi HARADA, Hiroshima (JP); Mizuho TAMURA, Hiroshima (JP)

(73) Assignee: KEYLEX CORPORATION, Hiroshima (JP)

(21) Appl. No.: 17/110,401

(22) Filed: Dec. 3, 2020

Related U.S. Application Data
(63) Continuation of application No. PCT/JP2019/011448, filed on Mar. 19, 2019.

(30) Foreign Application Priority Data
Jun. 4, 2018 (JP) 2018-107071
Jun. 12, 2018 (JP) 2018-111619

(51) Int. Cl. B25J 9/16; G05B 19/4155

(52) U.S. Cl. CPC B25J 9/1692; B25J 11/005; G05B 19/4155; B25J 9/1671

(57) ABSTRACT

Actual coordinate system data is acquired on the basis of a coordinate position at which a coordinate system generating tool attached to a robot is brought into proximity to, or contact to a coordinate system generating target of a coordinate system generating unit attached to a work piece positioning device. Simulation teaching data of a movement trajectory of a welding gun and design coordinate system data based on a design coordinate value of a coordinate system generating target are acquired by using a virtual model. After the actual coordinate system data is acquired into an information processing system, a coordinate position of the simulation teaching data is then moved to match the design coordinate system data with the actual coordinate system data.

### CROSS-REFERENCE TO RELATED APPLICATIONS

This application is a continuation of International Application No. PCT/JP2019/011448, filed on Mar. 19, 2019, which claims priority from Japanese Patent Application No. 2018-107071 filed on Jun. 4, 2018 and Japanese Patent Application No. 2018-111619 filed on Jun. 12, 2018, the contents of both are incorporated herein by reference in their entirety.

### BACKGROUND OF THE DISCLOSURE

### 1. Field of the Disclosure

The present disclosure relates to a method for generating teaching data enabling a multi-joint robot to execute a movement trajectory of a tool attached to an arm distal end of the multi-joint robot that works on a component mounted on a fixture in an automobile production line, for example, and to a teaching data calibration coordinate system detector for use in acquiring on site coordinate system data that is utilized for calibrating teaching data taking into account discrepancies to design values of equipment when the teaching data is generated in a virtual space in an information processing system.

### 2. Description of the Related Art

Generally, a large number of multi-joint robots instead of humans perform tasks in production lines for automobiles, for example. These multi-joint robots play back movements of a tool attached to its arm distal end, based on previously generated teaching data. In recent years, this teaching data is first generated in offline operation while a pose of a robot is assessed on a robot three-dimensionally displayed as data using an information processing system, such as, a workstation or computer, and subsequently the generated teaching data is written for use into a controller of a robot mounted in a production line.

Then, when the teaching data generated in offline operation as described above is written without a change into the controller of the robot installed on site, the robot may contact to a work body, such as a fixture, during a movement due to, for example, variation in installing positions of the robot and the fixture installed in the production line.

For avoiding such event, for example, Japanese Laid-Open Patent Publication No. 2000-288742 describes that variation in a positional relationship between a robot and a work body being worked on with the robot, in an information processing system, is calibrated taking into account variation in installing positions of a robot and a work body in a production line. Specifically, on a site of the production line, while a first reference device (stationary gun) having a coordinate system generating target serving as reference is attached to a work body, a second reference device is attached to an arm distal end of a robot. Thereafter, the robot is operated to bring the second reference device into proximity to, or contact to the coordinate system generating target in order to acquire actual coordinate system data from a coordinate position of the coordinate system generating target. On the other hand, in an information processing system, design coordinate system data is acquired on the basis of a design coordinate position of the coordinate system generating target at the work body by using a virtual model. Then, the actual coordinate system data is acquired into the information processing system and a coordinate position of the work body is moved to match the design coordinate system data with the actual coordinate system data. The relative positional relationship between the robot and the work body in the information processing system is thus in line with the relative positional relationship between the robot and the work body in the actual production line.

### SUMMARY

In this regard, in the case of a process in which a plurality of robots work on one work body, variation in the relative positional relationship of the robot with the work body occurs for each robot on site. When the coordinate position of the work body is moved in the information processing system as described in JP2000-288742, larger difference is created between the work body and other robots except the robot calibrated for the variation in the relative positional relationship with the work body. Thus, when teaching data generated with the other robots except the robot calibrated to the work body is written into a controller of a robot installed on site, the installed robot may have a higher likelihood of contacting to the work body during a movement.

The robot installed on site and a tool attached to the robot then have assembly errors between the tool and the robot, installation errors of the robot, as well as instrumental difference of the robot and tool as such, for example. JP2000-288742 does not disclose at all as to how the effect of those on the teaching data are solved.

The present disclosure is made in view of the foregoing and an object of the present disclosure is to generate, in an information processing system, teaching data for a multi-joint robot which takes into account variation in equipment mounted on site even when multiple robots work on one work body.

The present disclosure is characterized by calibrating, in an information processing system, a movement trajectory of a tool located at an arm distal end of a robot, to achieve the object.

Specifically, the present disclosure is directed to a multi-joint robot teaching data generation method for generating teaching data enabling a robot to execute, in equipment including one or more multi-joint robots and a work body on which the robots work, a movement trajectory in operation of a tool attached to an arm distal end of the robot, with respect to the work body. The following solutions are then applied.

According to a first aspect of the present disclosure, the method includes the steps of: coordinate system data acquisition where a first reference device including a coordinate system generating target serving as a reference position is attached to the work body and a second reference device is attached to the tool, and subsequently a first coordinate system data is acquired on the basis of a coordinate position of the second reference device brought into proximity to, or contact to the coordinate system generating target by operating the robot; precalibration teaching data acquisition where simulation teaching data of the movement trajectory and design coordinate system data based on a design coordinate position of the coordinate system generating target are acquired by reproducing a virtual model of the equipment and using the virtual model in an information processing system, or acquired teaching data of the movement trajectory having already acquired on another equipment having the same configuration as the equipment, and second coordinate system data acquired using the first and second reference devices with respect to a reference position of a work body in the other equipment are acquired into the information processing system; teaching data calibration where the first coordinate system data is acquired into the information processing system, and subsequently a coordinate position of the simulation teaching data is moved such that the design coordinate system data coincides with the first coordinate system data, or a coordinate position of the acquired teaching data is moved such that the second coordinate system data coincides with the first coordinate system data, to calibrate the simulation teaching data or the acquired teaching data; and final teaching data acquisition.

According to a second aspect of the present disclosure which is an embodiment of the first aspect, the first reference device includes a plurality of the coordinate system generating targets provided spaced apart at a predetermined distance, and the simulation teaching data or the acquired teaching data is region data representing a plurality of regions divided, and the final teaching data is acquired by calibrating the region data of each region using the coordinate system generating target located closest to the region.

The present disclosure is also directed to a teaching data calibration coordinate system detector for use in performing the multi-joint robot teaching data generation method of the first aspect, and the detector configured to be removably attached to equipment that includes the work body including a fixture on which the tool attached to the arm distal end of the robot works, and a support configured to replaceably support the fixture, and the detector for use in acquiring the first and second coordinate system data from the equipment for generating the teaching data in a virtual space in the information processing system. The following solutions are then applied.

According to a third aspect of the present disclosure, the detector includes a first reference device having a coordinate system generating target including first, second, and third marker portions provided spaced apart at a predetermined distance, the first reference device configured to be secured to the support by using a mounting unit for positionably attaching the fixture to the support, when the fixture is removed from the support; and a second reference device configured to be detachably attached to the tool, the second reference device having an end portion capable of being brought into proximity to, or contact to the first, second, and third marker portions as the tool moves with a movement of the arm.

According to a fourth aspect of the present disclosure which is an embodiment of the third aspect, the first marker portion is spindle-shaped and has at an end thereof a pointed first apex portion serving as a marker, the second marker portion is triangular in cross sectional view and has at an end thereof a linear second apex portion serving as a marker, and the third marker portion is triangular in cross sectional view and has at an end thereof a linear third apex portion serving as a marker.

According to a fifth aspect of the present disclosure which is an embodiment of the third aspect, the first reference device includes a base frame configured to be secured to the support by using the mounting unit, and the base frame includes a plurality of the coordinate system generating targets provided spaced apart at a predetermined distance.

According to a sixth aspect of the present disclosure which is an embodiment of the third aspect, the mounting unit is provided at a plurality of locations on the support.

According to the first aspect of the present disclosure, a relative positional relationship between the teaching data generated for each of the robots in the information processing system and the work body is calibrated by moving the teaching data with respect to the work body. Thus, even when there are one or more of the robots working on the work body in a process, the teaching data previously taking into account relative variation in the robots being at the work body on site can be generated in the information processing system. The movement trajectory of the tool is then calibrated instead of the position of the tool or the robot as such, thus allowing the movement of the robot to have reduced effect of difference caused by assembly errors between the tool and the robot body and installation errors of the robot body on site, when the teaching data generated in the information processing system is written into and executed by the control panel of the robot installed on site. Corrections of the teaching data on site which are caused by errors with respect to the design values of the robots installed on site can be thus reduced.

According to the second aspect of the present disclosure, the teaching data is calibrated for each region adjacent to the respective coordinate system generating targets, thus enabling the final teaching data to have reduced effect of variation caused by instrumental difference of the robots between the movements of the tool in regions adjacent to and away from the coordinate system generating target used for the calibration.

According to the third aspect of the present disclosure, the actual coordinate system data can be acquired by bringing the second reference device attached to the tool into proximity to, or contact to the first, second, and third marker portions of the coordinate system generating target attached to the support by means of the mounting unit, to detect the coordinate position of the coordinate system generating target. The device serving as reference can be attached to the equipment by means of the mounting unit that is used when the fixture is replaced with respect to the support, thus allowing avoidance of an increasing number of components and higher cost. Further, the device serving as reference is attached to the equipment by means of the mounting unit configured to precisely position the fixture with respect to the support, thus enabling precise positioning of the device serving as reference on the equipment.

According to the fourth aspect of the present disclosure, when the end portion of the second reference device is brought into proximity to, or contact to the first, second, and third marker portions, it is facilitated that an operator visually brings the end portion of the second reference device into proximity to, or contact to the first, second, and third marker portions. This enables efficient operation of acquiring the coordinate positions for generating the coordinate system data.

According to the fifth aspect of the present disclosure, the coordinate system data used in the calibration can be generated at the plurality of locations. The coordinate system data generated using the coordinate system generating target located at an optimal position can be thus utilized as coordinate system data that is used for calibrating the teaching data. For example, the teaching data is calibrated for each region adjacent to the respective coordinate system generating targets, enabling the calibrated teaching data to have reduced effect of variation caused by instrumental difference of the robots between the movements of the tool in regions adjacent to and away from the coordinate system generating target used for the calibration.

According to the sixth aspect of the present disclosure, when the teaching data is generated for each of the fixtures on the equipment that has the fixtures at a plurality of location, one detector only needs to be available, thus allowing a reduced number of components and lower cost.

### BRIEF DESCRIPTION OF DRAWINGS

FIG. 1 is a schematic front view of a welding production line including a placed vertical multi-joint robot configured to play back a movement on the basis of teaching data generated by a teaching data generation method according to an embodiment of the present disclosure.

FIG. 2 is a fragmentary view corresponding a view taken in the direction of arrow II indicated in FIG. 1.

FIG. 3 is a partially enlarged view of FIG. 2 showing a movement trajectory in operation of a welding gun attached to an arm distal end of the robot.

FIG. 4 is a view seen from below of a fixture configured to be removably attached to a workpiece positioning device.

FIG. 5 is a schematic plan view showing a state immediately before positioning a fixture with respect to a supporting frame at a bottom portion and a center of the fixture upon changing the fixture.

FIG. 6 is a view taken in the direction of arrow VI indicated in FIG. 5.

FIG. 7 is a schematic plan view showing a state immediately after positioning the fixture with respect to the supporting frame at the bottom portion and the center of the fixture upon changing the fixture.

FIG. 8 is a view taken in the direction of arrow VIII indicated in FIG. 7.

FIG. 9 is a schematic plan view showing a state immediately before positioning a fixture with respect to a supporting frame at a longitudinal end of the fixture upon changing the fixture.

FIG. 10 is a view taken in the direction of arrow X indicated in FIG. 9.

FIG. 11 is a schematic plan view showing a state immediately after positioning the fixture with respect to the supporting frame at the longitudinal end of the fixture upon changing the fixture.

FIG. 12 is a view taken in the direction of arrow XII indicated in FIG. 11.

FIG. 13 is a fragmentary view taken in the direction of arrow XIII in FIG. 2, showing a state immediately before securing a fixture to a supporting frame.

FIG. 14 is a fragmentary view showing a state immediately after securing the fixture to the supporting frame, following the state shown in FIG. 13.

FIG. 15 is a fragmentary view taken in the direction of arrow XV in FIG. 2, showing a state immediately before securing the fixture to the supporting frame.

FIG. 16 is a fragmentary view showing a state immediately after securing the fixture to the supporting frame, following the state shown in FIG. 15.

FIG. 17 is a perspective view illustrating a first reference device according to an embodiment of the present disclosure.

FIG. 18 is a view of the first reference device seen from below.

FIG. 19 is a view corresponding to FIG. 2 showing a state where a robot is operated to acquire actual coordinate system data on equipment on site.

FIG. 20 is a fragmentary view taken in the direction of arrow XX indicated in FIG. 17.

FIG. 21 is a fragmentary view taken in the direction of arrow XXI indicated in FIG. 17.

FIG. 22 is a fragmentary view taken in the direction of arrow XXII indicated in FIG. 17.

FIG. 23 is a perspective view illustrating a second reference device according to an embodiment of the present disclosure.

FIG. 24 is a schematic block diagram of an information processing system used in an embodiment of the present disclosure.

FIG. 25 is a block diagram showing process for a teaching data generation method according to an embodiment of the present disclosure.

FIG. 26 is a perspective view of a first reference device displayed in a display unit of an information processing system, showing a state immediately before calibrating a portion of region of simulation teaching data generated in the information processing system.

FIG. 27 is a view showing a state immediately after acquiring a portion of region of final teaching data, following the state shown in FIG. 26.

FIG. 28 is a view showing a state immediately before a portion of region of the simulation teaching data is calibrated to acquire the final teaching data, following the state shown in FIG. 27.

FIG. 29 is a view showing a state immediately after acquiring the final teaching data, following the state shown in FIG. 28.

### DETAILED DESCRIPTION

Embodiments of the present disclosure are described in detail below with reference to the drawings. It is noted that following description of preferred embodiments is merely an example in nature.

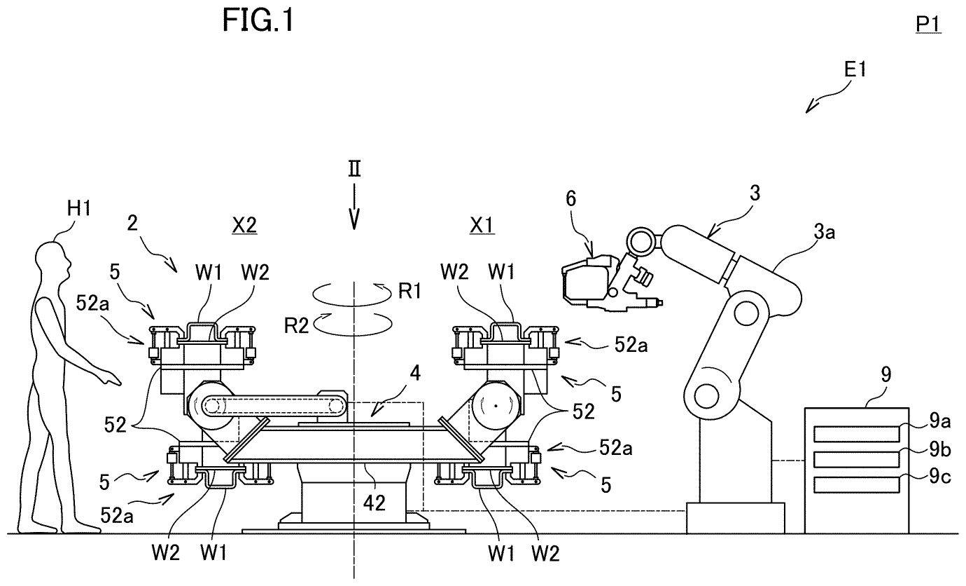

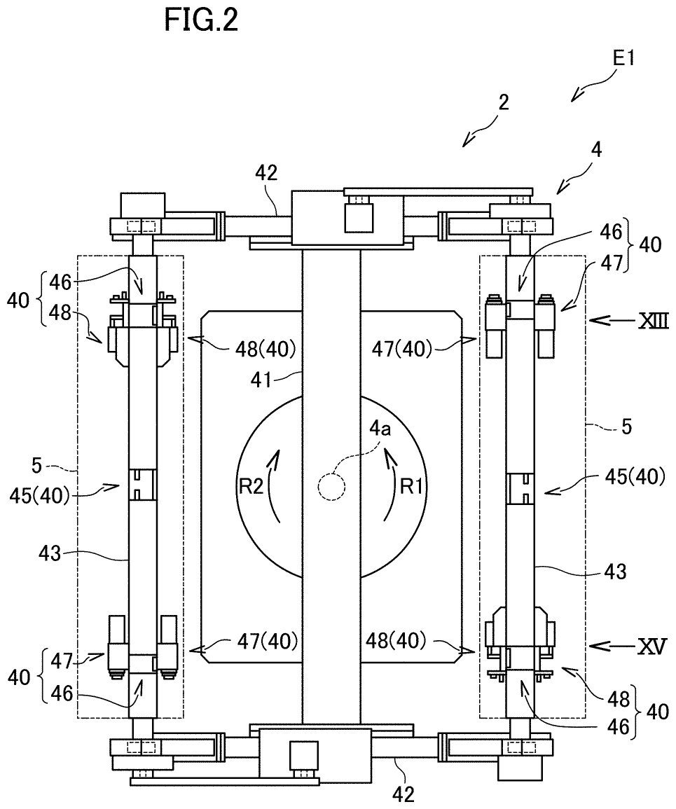

FIGS. 1 and 2 illustrate a production line P1 according to an embodiment of the present disclosure. In the production line P1, two press-formed work pieces w1, w2 are assembled to be integral by means of spot welding. Production equipment E1 is mounted in the production line P1. The production equipment E1 includes a work piece positioning device 2 (work body) configured to position the work pieces w1, w2, and a pair of vertical multi-joint robots 3 configured to perform welding. While the robots 3 perform tasks on the work piece positioning device 2, an operator H1 sets the work pieces w1, w2 on the work piece positioning device 2 on an opposite side of the work piece positioning device 2 from the robots 3.

The work piece positioning device 2 includes a rotary frame 4 (support) arranged in a grid as viewed in plan and having at a center thereof a vertically extending rotation shaft 4a, and four fixtures 5 configured to position the work pieces w1, w2. The rotary frame 4 rotates alternately in a direction of R1 (forward direction) and in a direction of R2 (reverse direction) between a position associated with the robots 3 (hereinafter referred to as work piece welding region X1) and a position associated with the operator H1 (hereinafter referred to as work piece setting region X2).

The rotary frame 4 includes a first horizontal frame 41 extending horizontally to both sides of the rotation shaft 4a such that the first horizontal frame 41 is symmetrically disposed across the rotation shaft 4a, and a pair of second horizontal frames 42 each extending horizontally and orthogonally to the first horizontal frame 41 from respective longitudinal ends of the first horizontal frame 41 such that the second horizontal frames 42 are symmetrically disposed interposing the first horizontal frame 41, and a pair of supporting frames 43 configured to bridge between one longitudinal ends of the second horizontal frames 42 and between another longitudinal ends of the second horizontal frames 42, respectively, and to each removably support fixtures 5 such that one fixture is located above the supporting frame 43 and one fixture below.

The second horizontal frames 42 both support each of the supporting frames 43 such that the supporting frame 43 is rotatable about a central axis of the supporting frame 43. Positions of the fixtures 5 that are attached to each of the supporting frames 43 and located above and below can be alternately switched by the rotation movement of associated one of the supporting frames 43.

Each of the supporting frames 43 is rectangle in cross sectional view. A first fixture fixing part 45 is then provided on each of top and bottom surfaces of the supporting frame 43 at a longitudinal center of the supporting frame 43.

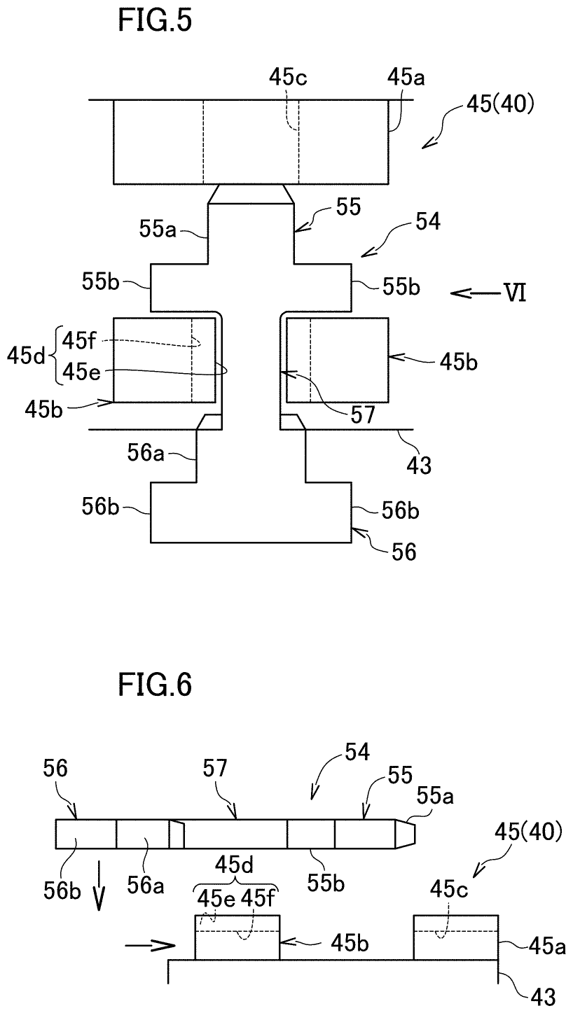

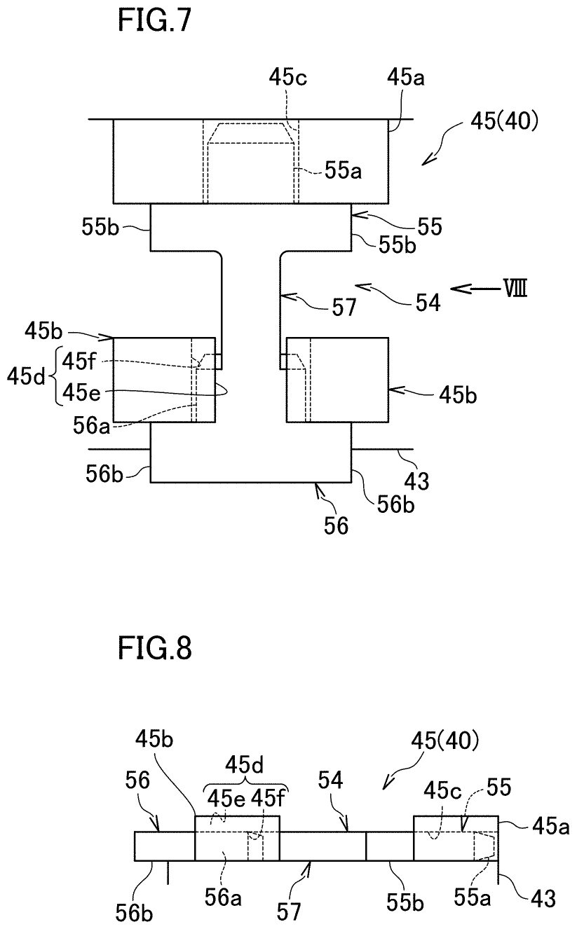

As illustrated in FIGS. 5 to 8, the first fixture fixing part 45 located on the top surface of each of the supporting frames 43 includes a first block 45a located on a first horizontal frame 41 side of the first fixture fixing part 45, and a pair of second blocks 45b provided at a predetermined distance from the first block 45a on an opposite side of the first block 45a from the first horizontal frame 41 and spaced apart at a predetermined distance in a longitudinal direction of the supporting frame 43.

A fixing hole 45c is formed in a center of the first block 45a and extends through horizontally and orthogonally to the longitudinal direction of the supporting frame 43 to open to both the first horizontal frame 41 side and the opposite side.

Between the second blocks 45b, an engageable recess 45d is formed of opposing portions of the second blocks 45b and the top surface of the supporting frame 43. The engageable recess 45d extends horizontally and orthogonally to the supporting frame 43 and has both ends that are each open.

The engageable recess 45d includes a slitted opening 45e extending horizontally and orthogonally to the longitudinal direction of the supporting frame 43, and a widened portion 45f continuous with the opening 45e to extend to the longitudinal direction of the supporting frame 43. The engageable recess 45d is generally T-shaped in cross sectional view.

The first fixture fixing part 45 located on the bottom surface of each of the supporting frames 43 is then only arranged in a point symmetrical manner to the first fixture fixing part 45 located on the top surface of associated one of the supporting frames 43, as viewed in a direction of the rotation axis of the supporting frame 43, and therefore, the detailed explanation thereof is omitted.

A second fixture fixing part 46 is provided on the top and bottom surfaces of each of the supporting frames 43 adjacent to respective longitudinal ends of the supporting frame 43. The second fixture fixing parts 46 located on one longitudinal ends of the supporting frames 43 and the second fixture fixing parts 46 located on another longitudinal ends of the supporting frames 43 are located at an equal distance from associated one of the first fixture fixing parts 45.

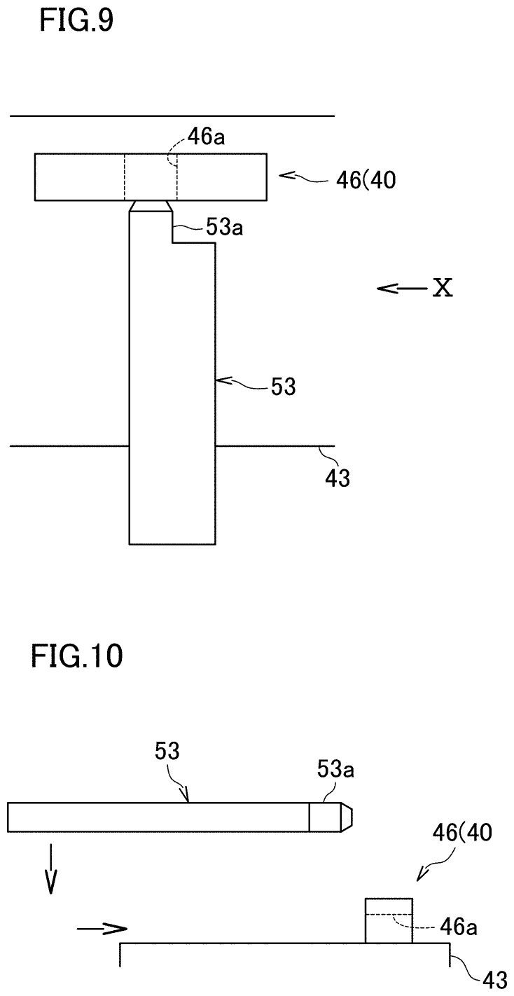

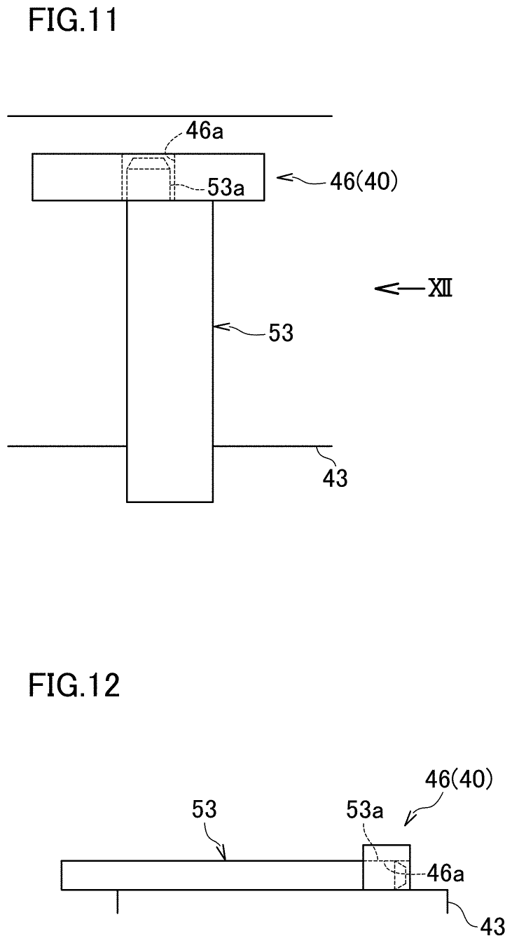

As illustrated in FIGS. 9 to 12, the second fixture fixing part 46 located on the top surface of each of the supporting frames 43 is block-shaped and located on the first horizontal frame 41 side. A fixation assisting hole 46a is formed at a center of the second fixture fixing part 46 and extends through horizontally and orthogonally to the longitudinal direction of the supporting frame 43 to open to both the first horizontal frame 41 side and the opposite side.

The second fixture fixing part 46 located on the bottom surface of each of the supporting frames 43 is then only arranged in a point symmetrical manner to the second fixture fixing part 46 located on the top surface of associated one of the supporting frames 43, as viewed in the direction of the rotation axis of the supporting frame 43, and therefore, the detailed explanation thereof is omitted.

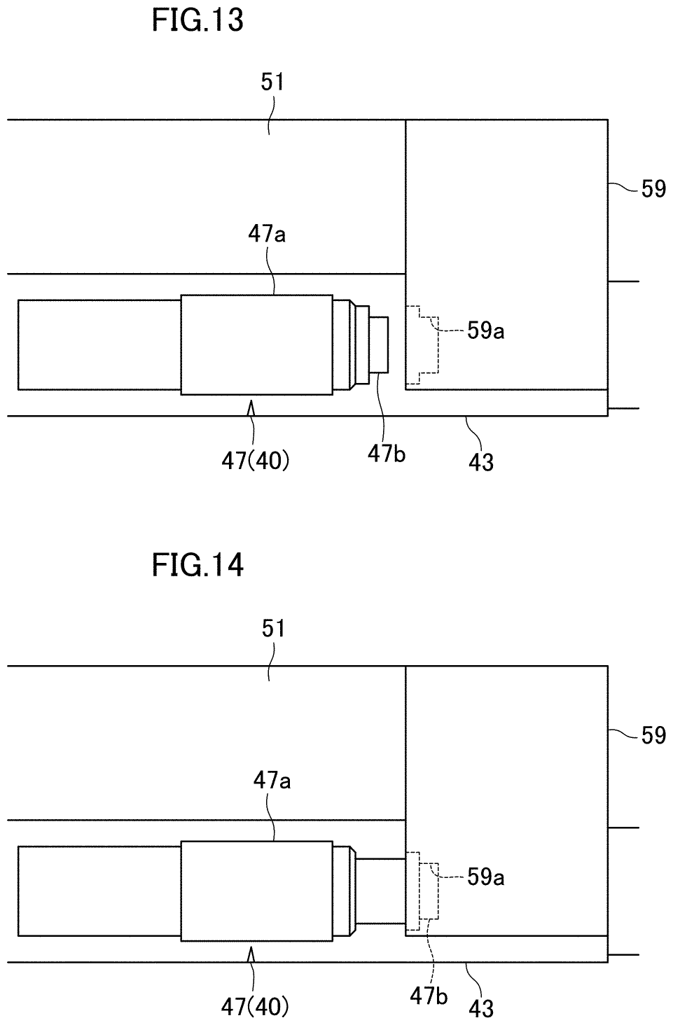

As illustrated in FIGS. 13 and 14, a pair of first fixing units 47 for securing the fixture 5 to the support frame 43 are provided on respective side surfaces of each of the support frames 43 adjacent to the one longitudinal end of the support frame 43.

The first fixing unit 47 includes a unit body 47a extending along the longitudinal direction of the supporting frame 43, and a first engaging pin 47b arranged movably toward the longitudinally outward direction of the supporting frame 43.

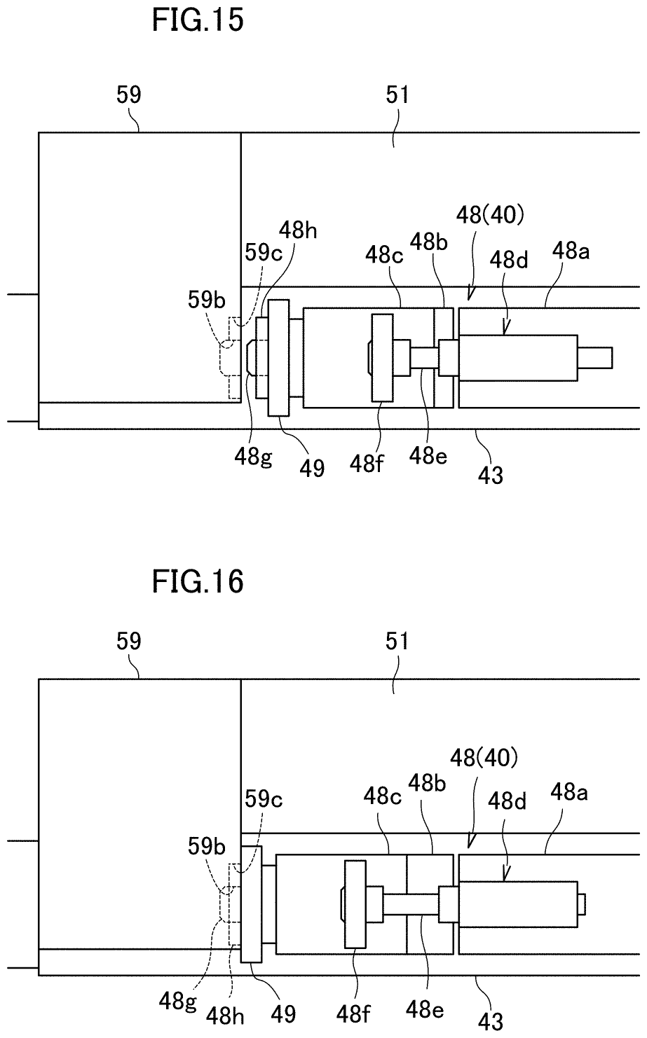

As illustrated in FIGS. 15 and 16, a pair of second fixing units 48 for fixing the fixture 5 to the support frame 43 are then provided on respective side surfaces of each of the support frames 43 adjacent to the other longitudinal end of the support frame 43.

The second fixing units 48 include a block-shaped fixed base 48a fixed to the supporting frame 43; a slider rail 48b fixed adjacent to the fixed base 48a on the supporting frame 43 and extending in the longitudinal direction of the supporting frame 43; a slider plate 48c configured to slidably fit with the slider rail 48b; and a hydraulic cylinder 48d mounted to the fixed base 48a. The hydraulic cylinder 48d includes a piston rod 48e configured to extend and retract in the longitudinal direction of the supporting frame 43, and the piston rod 48e includes a distal end connected to the slider plate 48c via a connecting member 48f.

A rectangle plate 49 is attached to an end of the slider plate 48c opposite from the fixed base 48a. A second engaging pin 48g, and a rectangular, plate-shaped first connector 48h connecting to wiring of the rotary frame 4 are arranged side by side on a surface of the rectangle plate 49 opposite from the fixed base 48a.

When the piston rod 48e of the hydraulic cylinder 48d extends or retracts, a sliding movement of the slider plate 48c causes the second engaging pin 48g and the first connector 48h to extend or retract in the longitudinal direction of the supporting frame 43.

Thus, the first engaging pins 47b and the second engaging pins 48g are horizontally spaced apart at a predetermined distance. The fixture fixing part 45 is located at a center between the first engaging pins 47b and the second engaging pins 48g.

As illustrated in FIGS. 1 to 4, the fixture 5 includes an aluminum alloy main frame 51 being U-shaped in cross sectional view and extending horizontally and opening downwardly, and an iron supporting base 52 being plate-shaped and fixed to a top surface of the main frame 51 and extending along the main frame 51. A plurality of holders 52a for holding overlapped portions of the work pieces w1, w2 are attached to the supporting base 52.

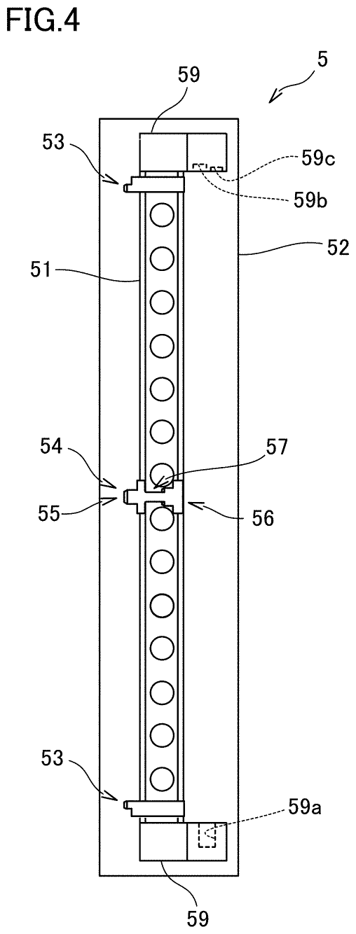

As illustrated in FIGS. 4 to 8, a fixing frame 54 extending horizontally and orthogonally to the main frame 51 is attached to a bottom portion of the main frame 51 at a longitudinal center of the main frame 51.

The fixing frame 54 is formed such that a projection part 55 and an engagement part 56 being each T-shaped in planar view are connected by a linear connecting part 57 extending horizontally and orthogonally to the main frame 51.

The projection part 55 includes a projecting nail 55a projecting horizontally and orthogonally to the main frame 51 to jut out from the main frame 51, and configured to detachably engage with the fixing hole 45c; and a pair of front extensions 55b extending horizontally to respective sides of the projecting nail 55a from a base end side of the projecting nail 55a.

The projection part 55 has a projection, the length of which is designed to be smaller than a length between the first block 45a and both of the second blocks 45b.

A length of the connecting part 57 in a direction horizontal and orthogonal to the main frame 51 is designed to be larger than a length of the second blocks 45b in the direction horizontal and orthogonal to the main frame 51. A length of the connecting part 57 along a longitudinal direction of the main frame 51 is designed to be smaller than a length between the second blocks 45b.

The engagement part 56 includes an engaging nail 56a provided spaced apart at a predetermined distance opposite a projection direction of the projection part 55 and projecting in the same direction as the projecting nail 55a; and a pair of rear extensions 56b extending horizontally to respective sides of the engaging nail 56a from a base end side of the engaging nail 56a.

A width of the engaging nail 56a is larger than that of the connecting part 57.

As illustrated in FIG. 4, a pair of fixation assisting frames 53 extending horizontally and orthogonally to the main frame 51 are then provided on the main frame 51 on longitudinal one and another ends sides of the main frame 51.

As illustrated in FIGS. 9 to 12, the fixation assisting frame 53 is elongated plate-shaped. A fixation assisting nail 53a projecting in the same direction as the projecting nail 55a and detachably engaging with the fixation assisting hole 46a is provided in a portion of the fixation assisting frame 53 located longitudinally inwardly of the main frame 51.

When the fixture 5 is placed above the supporting frame 43 to align the connecting part 57 of the fixing frame 54 of the fixture 5 with the opening 45e of the engageable recess 45d, and the fixture 5 is then lowered, the connecting part 57 passes through the opening 45e, as illustrated in FIGS. 5 to 8.

As the fixture 5 is then moved in the projection direction of the projection part 55 in the state where the connecting part 5 has passed through the opening 45e, the projecting nail 55a is inserted through the fixing hole 45c and the engaging nail 56a engages with the widened portion 45f of the engageable recess 45d. A position of the fixture 5 is thus determined with respect to the supporting frame 43 along the longitudinal direction of the supporting frame 43.

Then, when the projecting nail 55a engages with the fixing hole 45c, each of the fixation assisting nails 53a is inserted through associated one of the fixation assisting holes 46a.

A pair of L-shaped frames 59 corresponding to two adjacent outer circumferential surfaces of the supporting frame 43 are attached to respective longitudinal ends of the main frame 51.

As illustrated in FIGS. 13 and 14, a first engageable hole 59a with which the first engaging pin 47b advances and engages is provided in a downwardly projecting portion of one of the L-shaped frames 59 to open longitudinally inwardly of the main frame 51.

As illustrated in FIGS. 15 and 16, a second engageable hole 59b with which the second engaging pin 48g advances and engages is provided in a downwardly projecting portion of another of the L-shaped frames 59 to open longitudinally inwardly of the main frame 51.

The first and second engageable holes 59a, 59b are located at a same distance from the fixing hole 45c.

A second connector 59c recessed in a rectangular shape and connecting to wiring of the fixture 5 is arranged side by side with the second engageable hole 59b in the downwardly projecting portion of the other of the L-shaped frames 59. The second connector 59c can connect to the first connector 48h.

A mounting unit 40 of the present disclosure is formed of the first fixture fixing part 45, the second fixture fixing part 46, the first fixing unit 47, and the second fixing unit 48 of each of the supporting frames 43. Once the projecting nail 55a is inserted through the fixing hole 45c, the first engaging pin 47b and the second engaging pin 48g are located corresponding to the first engageable hole 59a and the second engageable hole 59b. On one hand, when the first engaging pin 47b and the second engaging pin 48g are advanced and engaged with the first engageable hole 59a and the second engageable hole 59b, respectively, the fixture 5 is attached to the supporting frame 43. On the other hand, when the first engaging pin 47b and the second engaging pin 48g are retracted and spaced away from the first engageable hole 59a and the second engageable hole 59b, respectively, the fixture 5 is removed from the supporting frame 43.

Being advanced, the first connector 48h also engages with the second connector 59c and the wirings of the supporting frame 43 and the fixture 5 are then connected.

A welding gun 6 (tool) is attached to a distal end of an arm 3a of the robot 3, and welding can be performed with a pose of the welding gun 6 being freely changed.

A teaching data calibration coordinate system detector 1 can be attached to the production equipment E1.

The detector 1 is used to acquire actual coordinate system data 12 (first coordinate system data) that is utilized for calibrating taking discrepancies to design values of the production equipment E1 into consideration when teaching data 10 for the robot 3 is generated in a virtual space in an information processing system 11. The detector 1 includes a coordinate system generating unit 7 (first reference device).

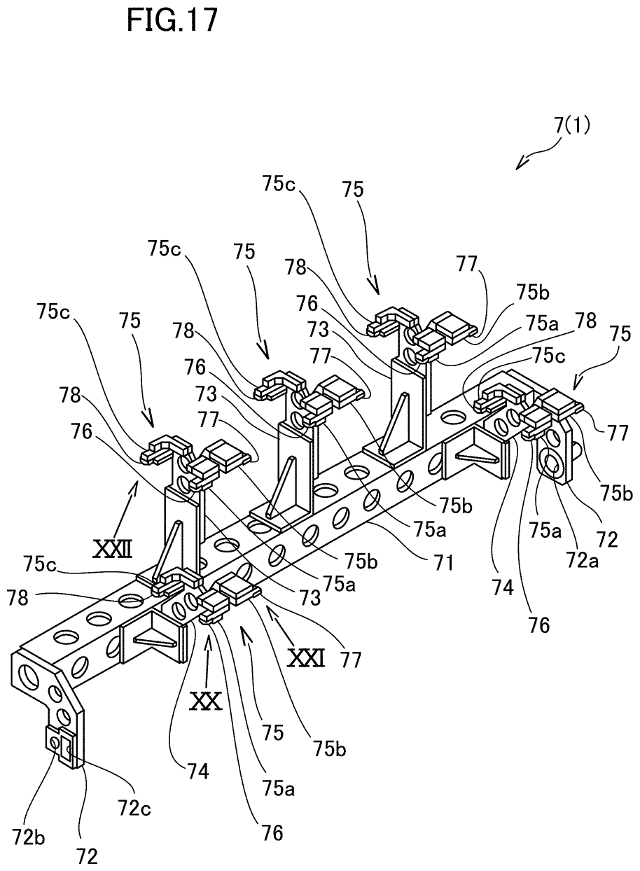

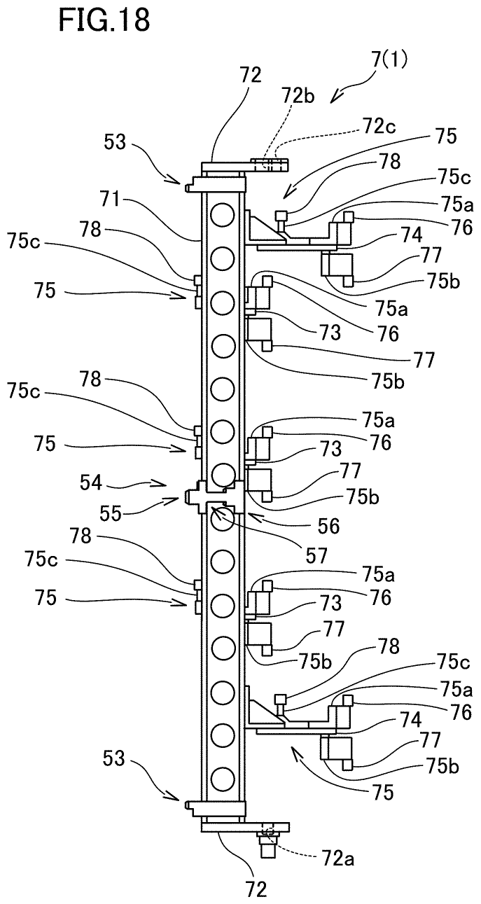

As illustrated in FIGS. 17 to 19, the coordinate system generating unit 7 includes a base frame 71 extending horizontally and being U-shaped in cross sectional view to open downwardly. The base frame 71 can be mounted on the top surface of the supporting frame 43.

A fixing frame 54 having the same configuration as one attached to the main frame 51 is attached to a bottom portion of the base frame 71 at a longitudinal center of the base frame 71.

A pair of fixation assisting frames 53 having the same configuration as those attached to the main frame 51 are attached to the base frame 71 on longitudinal one and another ends sides of the base frame 71.

The fixing frame 54 and both of the fixation assisting frames 53 of the base frame 71 are located to correspond to the fixing hole 45c and both of the fixation assisting holes 46a of the supporting frame 43, respectively. The coordinate system generating unit 7 can be secured to the supporting frame 43 as with the fixture 5. A positional relationship between the fixing hole 45c and both of the fixation assisting holes 46a is the same in each of the supporting frames 43. The coordinate system generating unit 7 can thus be attached to any of the supporting frames 43.

A pair of engageable plates 72 being generally L-shaped are fixed to respective ends of the base frame 71.

A first mounting hole 72a is formed in a downwardly projecting portion of one of the engageable plates 72. The first mounting hole 72 corresponds to the first engaging pin 47b of the first fixing unit 47 in the state where the base frame 71 is mounted on the supporting frame 43. When the first engaging pin 47b of the first fixing unit 47 is advanced, the first engaging pin 47b engages with the first mounting hole 72a to secure one side of the coordinate system generating unit 7 to the supporting frame 43.

A second mounting hole 72b and a third mounting hole 72c are formed in a downwardly projecting portion of another of the engageable plates 72. The second mounting hole 72b and the third mounting hole 72c correspond to the second engaging pin 48b and the first connector 48h of the second fixing unit 48, respectively, in the state where the base frame 71 is mounted on the supporting frame 43. When the second engaging pin 48b and the first connector 48h of the second fixing unit 48 are advanced, the second engaging pin 48b and the first connector 48h engage with the second mounting hole 72b and the third mounting hole 72c, respectively, to secure another side of the coordinate system generating unit 7 to the supporting frame 43.

Thus, each of the supporting frames 43 is configured to replaceably support the fixture 5 and also be able to support the coordinate system generating unit 7.

Three first mounting frames 73 extending upwardly are provided on a top surface of the base frame 71 to be spaced apart at a predetermined distance and at equal intervals in a longitudinal direction of the base frame 71.

Two second mounting frames 74 extending diagonally upwardly are provided on a side surface of the base frame 71 facing the robot 3 to be spaced apart at a predetermined distance in the longitudinal direction of the base frame 71. The second mounting frames 74 are each located outwardly of two of the three first mounting frames 73 located furthest.

A coordinate system generating target 75 is provided on an upper end of each of the first mounting frames 73 and second mounting frames 74.

The coordinate system generating target 75 includes a first branch portion 75a and a second branch portion 75b provided on a robot 3 side and extending opposite to each other along the longitudinal direction of the base frame 71, and a third branch portion 75c provided away from the robot 3 more than the first and second branch portions 75a, 75b and extending in the same direction as the first branch portion 75a. The first, second, and third branch portions 75a, 75b and 75c are spaced apart at a predetermined distance.

A first marker portion 76, a second marker portion 77, and a third marker portion 78 each being generally rectangle plate-shaped are respectively attached to bottom surfaces of the first, second, and third branch portions 75a, 75b and 75c on an extension end side.

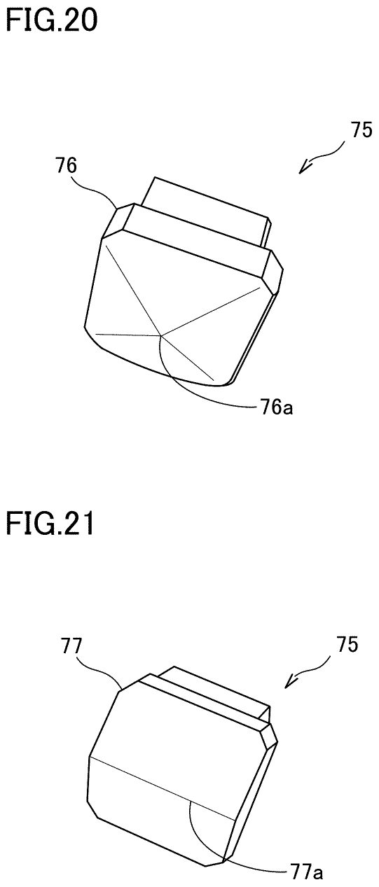

As illustrated in FIG. 20, a bottom surface of the first marker portion 76 includes a rectangular pyramid having gently-sloping pyramid faces and a diameter decreasing as extending downwardly, and has at an end a pointed first apex portion 76a serving as a marker.

As illustrated in FIG. 21, a bottom surface of the second marker portion 77 is triangular in cross sectional view with gently-sloping inclined faces, and a width in the longitudinal direction of the base frame 71 becoming smaller as extending downwardly, and has at an end a linear second apex portion 77a serving as a marker.

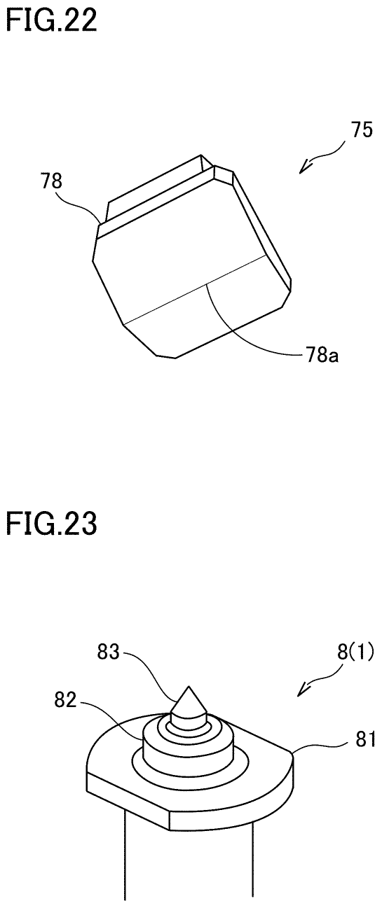

As illustrated in FIG. 22, a bottom surface of the third marker portion 78 is triangular in cross sectional view with gently-sloping inclined faces, and a width in a horizontal direction intersecting with the longitudinal direction of the base frame 71 becoming smaller as extending downwardly, and has at an end a linear third apex portion 78a serving as a marker.

The first apex portion 76a of the first marker portion 76, the second apex portion 77a of the second marker portion 77, and the third apex portion 78a of the third marker portion 78 are assured of being located in a same plane.

The coordinate system generating unit 7 is then configured such that the first engaging pin 47b, the second engaging pin 48g and the first connector 48h are located to correspond to the first mounting hole 72a, the second mounting hole 72b, and the third mounting hole 72c, respectively, in the state where the projecting nail 55a is inserted through the fixing hole 45c. On one hand, when the first engaging pin 47b, the second engaging pin 48g and the first connector 48h are advanced and engaged with the first mounting hole 72a, the second mounting hole 72b, and the third mounting hole 72c, respectively, the coordinate system generating unit 7 is attached to the supporting frame 43. On the other hand, when the first engaging pin 47b, the second engaging pin 48g and the first connector 48h are retracted and spaced away from the first mounting hole 72a, the second mounting hole 72b, and the third mounting hole 72c, respectively, the coordinate system generating unit 7 is removed from the supporting frame 43.

The coordinate system generating unit 7 can be thus secured to the supporting frame 43 by using the mounting unit 40 when the fixture 5 is removed from the supporting frame 43.

A coordinate system generating tool 8 (second reference device) can be detachably attached to a distal end of a shank of the welding gun 6.

As illustrated in FIG. 23, the coordinate system generating tool 8 includes a tool main part 81 being generally oblong plate-shaped in planar view, and an upward extension 82 extending upwardly from a center portion of a top surface of the tool main part 81 to be a disk shape. A pin 83 (end portion) having a pointed end protrudes upwardly at a center of the upward extension 82.

As illustrated in FIG. 1, a control panel 9 is connected to the work piece positioning device 2 and the robots 3.

The control panel 9 includes a fixture switching controller 9a for switching positions of the fixtures 5, a data storage unit 9b capable of storing teaching data 10 (final teaching data) for both of the robots 3, and a data calculation unit 9c capable of calculating actual coordinate system data 12. The control panel 9 enables the robots 3 to execute, on the basis of the teaching data 10, a movement trajectory in operation of each of the welding guns 6 on the fixture 5.

The fixture switching controller 9a is configured to output an actuation signal to a drive motor (not shown) to rotate the rotary frame 4 about the rotation shaft 4a, such that the fixtures 5 are alternately moved between the work piece welding region X1 and the work piece setting region X2.

The fixture switching controller 9a is also configured to output an actuation signal to a drive motor (not shown) to rotate the supporting frames 43 such that two of the fixtures 5 attached to each of the supporting frames 43 are moved to positions above and below.

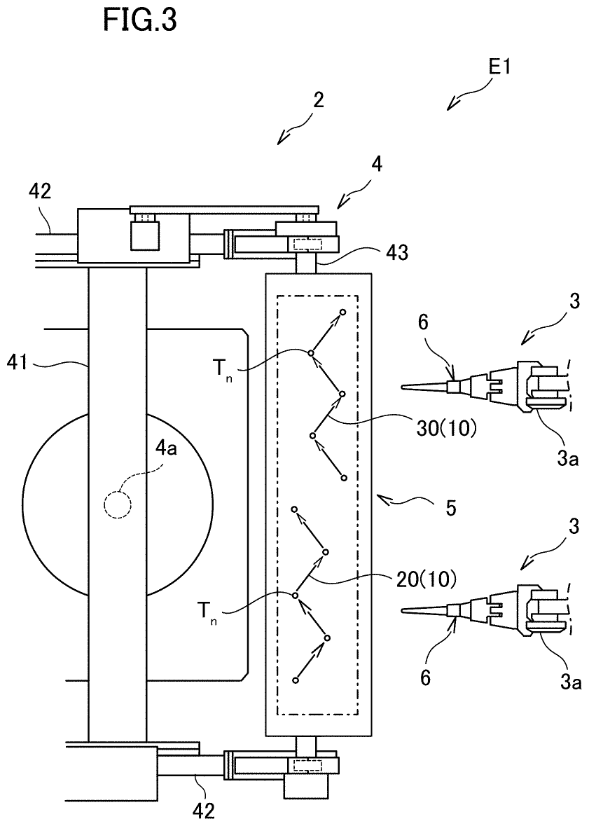

As illustrated in FIG. 3, the teaching data 10 stored in the data storage unit 9b includes first region data 20 used as a trajectory movement in operation of the welding gun 6 for one of the robots 3 at one side region along a longitudinal direction of the fixture 5, and second region data 30 used as a movement trajectory in operation of the welding gun 6 for another of the robots 3 at another side region along the longitudinal direction of the fixture 5.

The data storage unit 9b stores the first and second region data 20, 30 corresponding to each of the four fixtures 5.

The data storage unit 9b also stores coordinate positions of the end of the pin 83 of the coordinate system generating tool 8 when the arm 3a of the robot 3 is operated to bring the end of the pin 83 of the coordinate system generating tool 8 into proximity to, or contact to the first apex portion 76a of the first marker portion 76, the second apex portion 77a of the second marker portion 77, and the third apex portion 78a of the third marker portion 78 in the state where the coordinate system generating unit 7 is attached to the work piece positioning device 2 and the coordinate system generating tool 8 is attached to a distal end of a lower shank of the welding gun 6. In an embodiment of the present disclosure, while the end of the pin 83 of the coordinate system generating tool 8 is brought into proximity to, or contact to the first apex portion 76a of the first marker portion 76, the second apex portion 77a of the second marker portion 77, and the third apex portion 78a of the third marker portion 78 of the coordinate system generating target 75 located above on one side along a longitudinal direction of the coordinate system generating unit 7, and the data storage unit 9b then stores coordinate position for the target, the end of the pin 83 of the coordinate system generating tool 8 is brought into proximity to, or contact to the first apex portion 76a of the first marker portion 76, the second apex portion 77a of the second marker portion 77, and the third apex portion 78a of the third marker portion 78 of the coordinate system generating target 75 located above on another side along the longitudinal direction of the coordinate system generating unit 7, and the data storage unit 9b then stores coordinate position for the target.

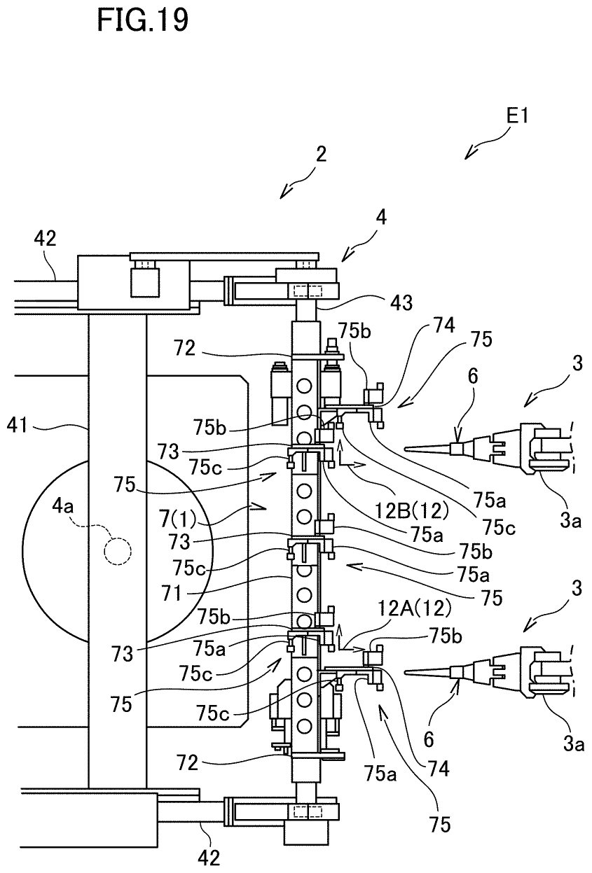

As illustrated in FIG. 19, the data calculation unit 9c is configured to calculate the actual coordinate system data 12 as described above, from the coordinate positions of the end of the pin 83 for the first, second, and third marker portions 76, 77, 78, which are stored in the data storage unit 9b. In the embodiment of the present disclosure, for reasons of convenience, the actual coordinate system data 12 acquired from the coordinate system generating target 75 located above on the one side along the longitudinal direction of the coordinate system generating unit 7 is called actual coordinate system data 12A, and the actual coordinate system data 12 acquired from the coordinate system generating target 75 located above on the other side along the longitudinal direction of the coordinate system generating unit 7 is called actual coordinate system data 12B.

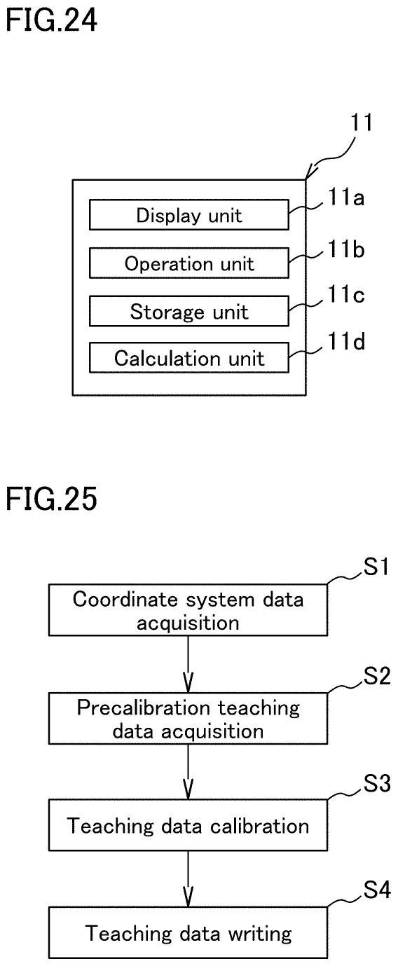

As shown in FIG. 24, the teaching data 10 is generated in offline operation by using the information processing system 11. The information processing system 11 includes a display unit 11a, an operation unit 11b, a storage unit 11c, and a calculation unit 11d.

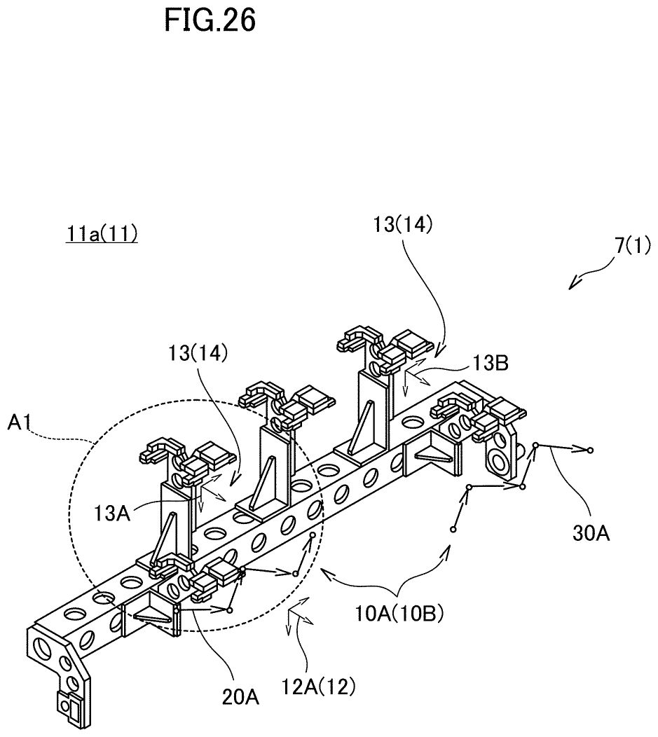

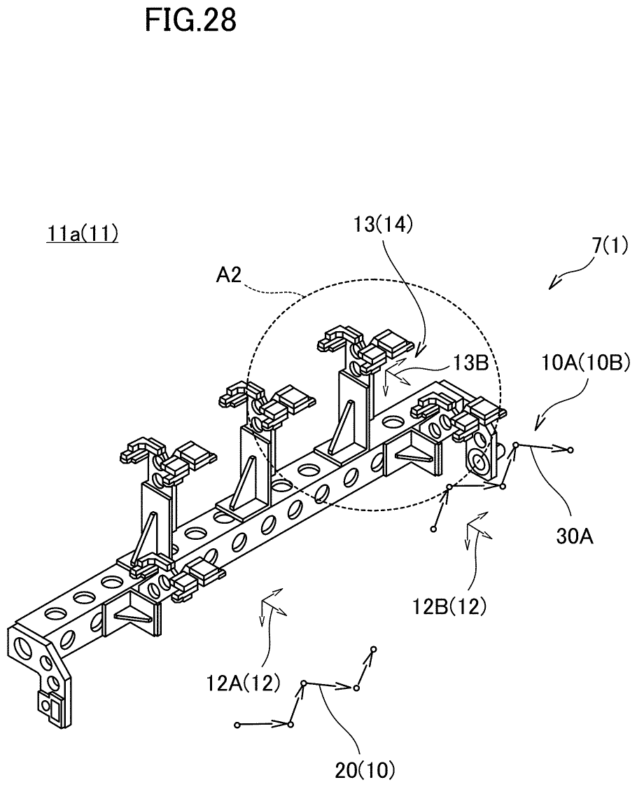

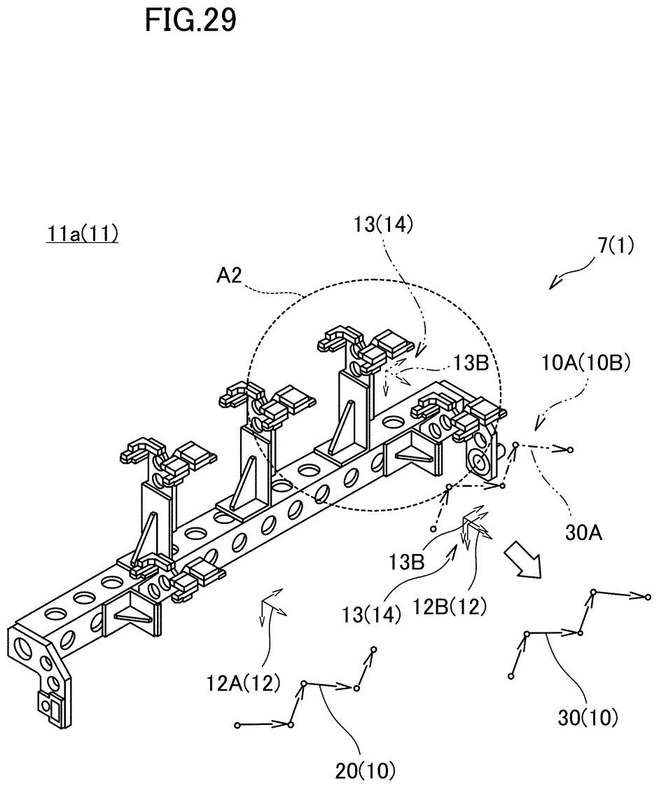

The display unit 11a can display a virtual model of, for example, the work piece positioning device 2, as illustrated in FIGS. 26 to 29, for example. In FIGS. 26 to 29, only the coordinate system generating unit 7 is shown in the display unit 11a. The virtual model shown in the display unit 11a then has reference characters same as those actually installed in the production line P1.

A virtual model of the robot 3 can be manipulated in the operation unit 11b. For example, an operator can assign multiple teaching points Tₙ (n is a natural number) serving as locations where the welding gun 6 performs welding, while operating the operation unit 11b in a three-dimensional virtual space.

The storage unit 11c stores virtual models of the work piece positioning device 2, the robot 3, the fixture 5, the welding gun 6, the coordinate system generating unit 7, and the coordinate system generating tool 8, and also can store simulation teaching data 10A for reproducing a movement of the arm 3a to move the welding gun 6 among the teaching points Tₙ in turn. In the embodiment of the present disclosure, as illustrated in FIG. 26, the storage unit 11c stores first region simulation data 20A used as a movement trajectory in operation of the welding gun 6 for the one of the robots 3 at the one side region along the longitudinal direction of the fixture 5, and second region simulation data 30A used as a movement trajectory in operation of the welding gun 6 for the other of the robots 3 at the other side region along the longitudinal direction of the fixture 5.

The storage unit 11c also acquires and stores the actual coordinate system data 12 obtained at the control panel 9.

The calculation unit 11d is configured to calculate design coordinate system data 13 based on design coordinate positions of first, second, and third marker portions 76, 77, 78 on a work piece positioning device 2 as a virtual model to store the design coordinate system data 13 in the storage unit 11c. In the embodiment of the present disclosure, while design coordinate system data 13 (hereinafter referred to as design coordinate system data 13A) is calculated from coordinate positions of first, second, and third marker portions 76, 77, 78 of a coordinate system generating target 75 located above on one side along a longitudinal direction of a coordinate system generating unit 7 as a virtual model, design coordinate system data 13 (hereinafter referred to as design coordinate system data 13B) is calculated by the calculation unit 11d from coordinate positions of first, second, and third marker portions 76, 77, 78 of the coordinate system generating target 75 located above on another side along the longitudinal direction of the coordinate system generating unit 7 as a virtual model.

By using the actual coordinate system data 12, the design coordinate system data 13, and the simulation teaching data 10A stored in the storage unit 11c, the calculation unit 11_{d} calculates to move coordinate positions of the simulation teaching data 10A such that the design coordinate system data 13 coincides with the actual coordinate system data 12, in order to acquire final teaching data 10.

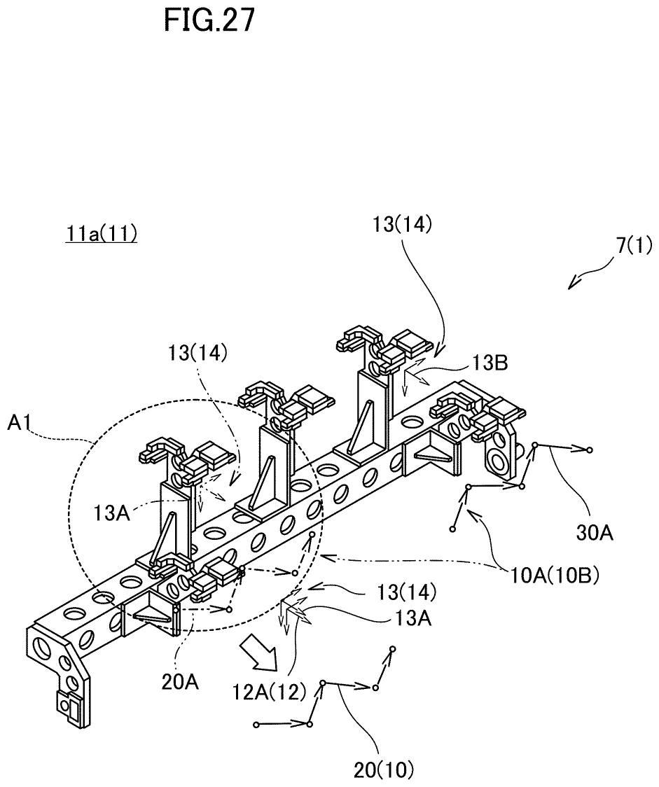

Specifically, as illustrated in FIGS. 26 and 27, while a coordinate position of the first region simulation data 20A is moved by using the design coordinate system data 13A acquired from the coordinate system generating target 75 located above on the one side along the longitudinal direction of the coordinate system generating unit 7 which is positioned closest to the first region simulation data 20A, a coordinate position of the second region simulation data 30A is moved by using the design coordinate system data 13B acquired from the coordinate system generating target 75 located above on the other side along the longitudinal direction of the coordinate system generating unit 7 which is positioned closest to the second region simulation data 30A.

Thus, when a certain area of space encompassing the coordinate system generating target 75 located above on the one side along the longitudinal direction of the coordinate system generating unit 7 is an area A1, a coordinate position of a portion of the simulation teaching data 10A located in the area A1 is moved by using the design coordinate system data 13A acquired from the coordinate system generating target 75 within the area A1. When a certain area of space encompassing the coordinate system generating target 75 located above on the other side along the longitudinal direction of the coordinate system generating unit 7 is an area A2, a coordinate position of a portion of the simulation teaching data 10A located in the area A2 is moved by using the design coordinate system data 13B acquired from the coordinate system generating target 75 within the area A2.

The teaching data 10 generated in the information processing system 11 is then written out from the information processing system 11 into the control panel 9 to be used for playback movements of the robots 3.

Next, a method for generating teaching data 10 in the information processing system 11 will be described in detail.

As illustrated in FIG. 3, the teaching data 10 generated includes first region data 20 used as a movement trajectory with which the welding gun 6 for the one of the robots 3 performs welding while changing a pose toward the one side along the longitudinal direction of the fixture 5 at the one side region along the longitudinal direction of the fixture 5, and second region data 30 used as a movement trajectory with which the welding gun 6 for the other of the robots 3 performs welding while changing a pose toward the other side along the longitudinal direction of the fixture 5 at the other side region along the longitudinal direction of the fixture 5.

As shown in FIG. 25, the teaching data 10 can be obtained by performing the processes of coordinate system data acquisition S1 for acquiring actual coordinate system data 12 in the production line P1, precalibration teaching data acquisition S2 for acquiring simulation teaching data 10A and design coordinate system data 13 by using a virtual model in the information processing system 11, teaching data calibration S3 for calculating final teaching data 10 in the information processing system 11, and teaching data writing S4 for writing out finally acquired teaching data 10 from the information processing system 11.

First, in the production line P1, one of the four fixtures 5 on the work piece positioning device 2 is removed and the coordinate system generating unit 7 is attached to a portion where the fixture 5 has been removed.

Next, the coordinate system generating tool 8 is attached to a distal end of a lower shank of the welding gun 6 for the robot 3 at the one side.

The end of the pin 83 of the coordinate system generating tool 8 is then brought into proximity to, or contact to the first apex portion 76a of the first marker portion 76, the second apex portion 77a of the second marker portion 77, and the third apex portion 78a of the third marker portion 78 of the coordinate system generating target 75 located above on the one side along the longitudinal direction of the coordinate system generating unit 7, and coordinate positions thereby obtained are stored in the data storage unit 9b.

In the data calculation unit 9c, actual coordinate system data 12A is then calculated on the basis of the coordinate positions of the end of the pin 83 stored in the data storage unit 9b.

Next, the coordinate system generating tool 8 is removed from the welding gun 6 for the robot 3 at the one side, and is then attached to a distal end of a lower shank of the welding gun 6 for the robot 3 at the other side.

The end of the pin 83 of the coordinate system generating tool 8 is then brought into proximity to, or contact to the first apex portion 76a of the first marker portion 76, the second apex portion 77a of the second marker portion 77, and the third apex portion 78a of the third marker portion 78 of the coordinate system generating target 75 located above on the other side along the longitudinal direction of the coordinate system generating unit 7, and coordinate positions thereby obtained are stored in the data storage unit 9b.

In the data calculation unit 9c, actual coordinate system data 12B is then calculated on the basis of the coordinate positions of the end of the pin 83 stored in the data storage unit 9b.

Next, in the information processing system 11, an operator manipulates in the operation unit 11b virtual models of the robots 3 displayed in the display unit 11a to generate first region simulation data 20A and second region simulation data 30A in a three-dimensional virtual space for storing in the storage unit 11c.

Design coordinate system data 13A is calculated by the calculation unit 11d from coordinate positions of first, second, and third marker portions 76, 77, 78 of a coordinate system generating target 75 located above on one side along a longitudinal direction of a coordinate system generating unit 7 which is a virtual model acquired into the information processing system 11, and then stored in the storage unit 11c.

Design coordinate system data 13B is calculated by the calculation unit 11d from coordinate positions of first, second, and third marker portions 76, 77, 78 of a coordinate system generating target 75 located above on another side along the longitudinal direction of the coordinate system generating unit 7 which is a virtual model acquired into the information processing system 11, and then stored in the storage unit 11c.

Thereafter, the first region data 20 is acquired by moving the coordinate position of the first region simulation data 20A by using the calculation unit 11d such that the design coordinate system data 13A coincides with the actual coordinate system data 12A, and the second region data 30 is acquired by moving the coordinate position of the second region simulation data 30A by using the calculation unit 11d such that the design coordinate system data 13B coincides with the actual coordinate system data 12B.

The first and second region data 20, 30 acquired are then written out from the information processing system 11 into the control panel 9 to be used for playback movements of the robots 3.

According to the embodiment of the present disclosure, a relative positional relationship between the first, second region simulation data 20A, 30A generated for each robot 3 in the information processing system 11 and the workpiece positioning device 2 is calibrated by moving the first and second region simulation data 20A, 30A with respect to the workpiece positioning device 2. Thus, even when there are one or more robots 3 working on the workpiece positioning device 2 in a process, the teaching data 10 previously taking into account relative variation in the robots 3 being at the workpiece positioning device 2 on site can be generated in the information processing system 11.

The movement trajectory of the welding gun 6 is then calibrated instead of a position of the welding gun 6 or the robot 3 as such, thus allowing the movement of the robot 3 to have reduced effect of difference caused by assembly errors between the welding gun 6 and the robot 3 and installation errors of the robot 3 on site, when the teaching data 10 generated in the information processing system 11 is written into and executed by the control panel 9 of the robot 3 installed on site. Corrections of the teaching data 10 on site which are caused by errors with respect to the design values of the robots 3 installed on site can be thus reduced.

Then, the teaching data 10 is calibrated for each region adjacent to the respective coordinate system generating targets 75, thus enabling the teaching data 10 to have reduced effect of variation caused by instrumental difference of the robots 3 between the movements of the welding guns 6 in regions adjacent to and away from the coordinate system generating target 75 used for the calibration.

The actual coordinate system data 12 then can be acquired by bringing the coordinate system generating tool 8 attached to the welding gun 6 into proximity to, or contact to the first, second, and third marker portions 76, 77, 78 of the coordinate system generating target 75 attached to the supporting frame 43 by means of the mounting unit 40, to detect the coordinate position of the coordinate system generating target 75.

Moreover, the coordinate system generating unit 7 used to acquire the actual coordinate system data 12 utilized for calibrating the simulation teaching data 10A generated in the information processing system 11, can be secured to the production equipment E1 by means of the mounting unit 40 that is used when the fixture 5 is replaced with respect to the supporting frame 43, thus allowing avoidance of an increasing number of components and higher cost.

The coordinate system generating unit 7 is then secured to the production equipment E1 by means of the mounting unit 40 configured to precisely position the fixture 5 with respect to the supporting frame 43, thus enabling precise positioning of the coordinate system generating unit 7 on the production equipment E1.

When the pin 83 of the coordinate system generating tool 8 is brought into proximity to, or contact to the first, second, and third marker portions 76, 77, 78, the first, second, and third apex portions 76a, 77a, 78a make it easier for an operator to visually bring the pin 83 of the coordinate system generating tool 8 into proximity, or contact thereto. This enables efficient operation of acquiring the coordinate positions for generating the actual coordinate system data 12.

Further, the plurality of the coordinate system generating targets 75 are provided on the coordinate system generating unit 7 and thus, the actual coordinate system data 12 used in the calibration can be generated at multiple locations. Accordingly, the actual coordinate system data 12 generated using the coordinate system generating target 75 located at an optimal position can be utilized as actual coordinate system data 12 that is used for calibrating the simulation teaching data 10A. For example, the teaching data 10 is calibrated for each region adjacent to the respective coordinate system generating targets 75, enabling the calibrated teaching data 10 to have reduced effect of variation caused by instrumental difference of the robots 3 between the movements of the welding guns 6 in regions adjacent to and away from the coordinate system generating target 75 used for the calibration.

In addition, as in the embodiment of the present disclosure, when four of the mounting units 40 are provided on the workpiece positioning device 2 and four of the fixtures 5 are removably attached to the workpiece positioning device 2, one detector 1 only needs to be available to generate the teaching data 10 for each of the fixtures 5, thus allowing a reduced number of components and lower cost.

In the embodiment of the present disclosure, the simulation teaching data 10A and the design coordinate system data 13 are acquired by using a virtual model in the information processing system 11 in the process of the precalibration teaching data acquisition S2; however, the embodiment is not limited to this configuration. Acquired teaching data 10B for a movement trajectory of the welding gun 6 for each of the robots 3 which has been already acquired on another production line having the same configuration as the production line P1, and another equipment associated coordinate system data 14 acquired using the coordinate system generating unit 7 and the coordinate system generating tool 8 in a workpiece positioning device 2 of the other production line may be acquired into the information processing system 11, and calculation in the process of the teaching data calibration S3 may be then performed by moving coordinate positions of the acquired teaching data 10B such that the other equipment associated coordinate system data 14 coincides with the actual coordinate system data 12, to obtain final teaching data 10. In this way, there is no need to generate the simulation teaching data 10A in the information processing system 11, thereby allowing shorter development time.

In the embodiment of the present disclosure, the movement trajectory of the welding gun 6 for each of the robots 3 then consists of one teaching data (first region data 20 or second region data 30); however, the embodiment is not limited to this configuration. The movement trajectory of the welding gun 6 for each of the robots 3 may consist of teaching data composed of a plurality of region data, and each region data may be calibrated using a closest coordinate system generating target 75.

The embodiment of the present disclosure describes a case where two of the robots 3 work on the workpiece positioning device 2. In this respect, the method of the present disclosure can be implemented even when one robot 3 works on the workpiece positioning device 2. The method of the present disclosure can be then implemented even when three or more robots 3 work on the workpiece positioning device 2.

Further, the teaching data 10 according to the embodiment of the present disclosure is for the movement trajectory of the robot 3 having the distal end of the arm 3a to which the welding gun 6 is attached. In this respect, a tool attached to the distal end of the arm of the robot 3 may be those other than the welding gun 6.

In the embodiment of the present disclosure, the coordinate system generating unit 7 is attached by using the mounting unit 40 to one of parts of the two supporting frames 43 to which the four fixtures 5 are attached, in order to acquire the actual coordinate system data 12. In this respect, the coordinate system generating unit 7 can be attached by using the mounting unit 40 even to three other parts of the two supporting frames 43 to which the four fixtures 5 are attached, in order to acquire final actual coordinate system data 12.

The present disclosure is suitable for a method for generating teaching data enabling a multi-joint robot to execute a movement trajectory of a tool attached to an arm distal end of the multi-joint robot that works on a component mounted on a fixture in an automobile production line, for example, and for a teaching data calibration coordinate system detector for use in acquiring on site coordinate system data that is utilized for calibrating teaching data taking into account discrepancies to design values of equipment when the teaching data is generated in a virtual space in an information processing system.

What is claimed is:

1. A multi-joint robot teaching data generation method for generating teaching data enabling a robot to execute, in equipment including one or more multi-joint robots and a work body on which the robots work, a movement trajectory in operation of a tool attached to an arm distal end of the robot, with respect to the work body, the method comprising the steps of:
coordinate system data acquisition where a first reference device including a coordinate system generating target serving as a reference position is attached to the work body and a second reference device is attached to the tool, and subsequently a first coordinate system data is acquired on the basis of a coordinate position of the second reference device brought into proximity to, or contact to the coordinate system generating target by operating the robot;
precalibration teaching data acquisition where simulation teaching data of the movement trajectory and design coordinate system data based on a design coordinate position of the coordinate system generating target are acquired by reproducing a virtual model of the equipment and using the virtual model in an information processing system, or acquired teaching data of the movement trajectory having already acquired on another equipment having the same configuration as the equipment, and second coordinate system data acquired using the first and second reference devices with respect to a reference position of a work body in the other equipment are acquired into the information processing system;
teaching data calibration where the first coordinate system data is acquired into the information processing system, and subsequently a coordinate position of the simulation teaching data is moved such that the design coordinate system data coincides with the first coordinate system data, or a coordinate position of the acquired teaching data is moved such that the second coordinate system data coincides with the first coordinate system data, to calibrate the simulation teaching data or the acquired teaching data; and
final teaching data acquisition.

2. The method according to claim 1, wherein the first reference device includes a plurality of the coordinate system generating targets provided spaced apart at a predetermined distance, and
the simulation teaching data or the acquired teaching data is region data representing a plurality of regions divided, and the final teaching data is acquired by calibrating the region data of each region using the coordinate system generating target located closest to the region.

3. A teaching data calibration coordinate system detector for use in performing the multi-joint robot teaching data generation method of claim 1, wherein the detector is configured to be removably attached to equipment that includes the work body including a fixture on which the tool attached to the arm distal end of the robot works, and a support configured to replaceably support the fixture, and the detector for use in acquiring the first and second coordinate system data from the equipment for generating the teaching data in a virtual space in the information processing system, the detector comprising:
a first reference device including a coordinate system generating target including first, second, and third marker portions provided spaced apart at a predetermined distance, and the first reference device configured to be secured to the support by using a mounting unit for positionably attaching the fixture to the support, when the fixture is removed from the support; and
a second reference device configured to be detachably attached to the tool, and having an end portion capable of being brought into proximity to, or contact to the first, second, and third marker portions as the tool moves with a movement of the arm.

4. The detector according to claim 3, wherein the first marker portion is spindle-shaped and has at an end thereof a pointed first apex portion serving as a marker, the second marker portion is triangular in cross sectional view and has at an end thereof a linear second apex portion serving as a marker, and the third marker portion is triangular in cross sectional view and has at an end thereof a linear third apex portion serving as a marker.

5. The detector according to claim 3, wherein the first reference device includes a base frame configured to be secured to the support by using the mounting unit, and the base frame includes a plurality of the coordinate system generating targets provided spaced apart at a predetermined distance.

6. The detector according to claim 3, wherein the mounting unit is provided at a plurality of locations on the support.
